(19) United States
(12) Patent Application Publication
(10) Pub. No.: US 2021/0248817 A1
(43) Pub. Date: Aug. 12, 2021

(54) DATA PROCESSING METHOD AND APPARATUS

(71) Applicant: SHENZHEN SENSETIME TECHNOLOGY CO., LTD., Shenzhen (CN)

(72) Inventors: Yingzhen CHEN, SHENZHEN (CN); Bin ZHU, SHENZHEN (CN); Gaoling CHEN, SHENZHEN (CN); Nengsheng QIAN, SHENZHEN (CN); Zhiying TAN, SHENZHEN (CN)

(21) Appl. No.: 17/241,545

(22) Filed: Apr. 27, 2021

Related U.S. Application Data
(63) Continuation of application No. PCT/CN2019/128444, filed on Dec. 25, 2019.

(30) Foreign Application Priority Data
Oct. 24, 2019 (CN) 201911017473.1

(51) Int. Cl. G06T 17/05; G06T 7/70; G06T 7/20; G06T 19/20; G06F 16/29; G06N 3/04; G06N 3/08

(52) U.S. Cl. CPC G06T 17/05; G06T 7/70; G06T 7/20; G06T 19/20; G06T 2219/2021; G06N 3/04; G06N 3/08; G06T 2200/08; G06T 2219/2012; G06F 16/29

(57) ABSTRACT

Embodiments of the present disclosure provide a data processing method and apparatus. According to a monitoring image captured at a monitoring point on a two-dimensional map, it is determined whether a map display level switching condition is satisfied. When the preset map display level switching condition is satisfied, position information of the monitoring point on the two-dimensional map is obtained, a map display level is switched from a two-dimensional map display level to a three-dimensional map display level, and a three-dimensional model associated with the position information is displayed in the three-dimensional map display level.

### CROSS REFERENCE TO RELATED APPLICATIONS

This application is a continuation of International Application No. PCT/CN2019/128444, filed on Dec. 25, 2019, which claims priority to Chinese Patent Application No. 201911017473.1, entitled “Data Processing Method and Apparatus” and filed on Oct. 24, 2019. The entire content of all of above applications is incorporated herein by reference.

### TECHNICAL FIELD

The present disclosure relates to the field of computer vision technology, and in particular, to data processing methods and apparatuses.

### BACKGROUND

As a form of a graphical language for recording geographical information, maps have wide application in daily production and life. With the continuous progress of technology, in addition to traditional two-dimensional maps, more and more three-dimensional maps begin to be put into practical applications.

### SUMMARY

The present disclosure provides data processing methods and apparatuses.

Specifically, the present disclosure is implemented by the following technical solutions.

According to a first aspect of embodiments of the present disclosure, a data processing method is provided, which includes:

obtaining a monitoring image captured at a monitoring point on a two-dimensional map;

determining, according to the monitoring image, whether a preset map display level switching condition is satisfied;

in response to determining that the preset map display level switching condition is satisfied, obtaining position information of the monitoring point on the two-dimensional map, and determining a three-dimensional model pre-associated with the position information;

switching a map display level from a two-dimensional map display level to a three-dimensional map display level; and displaying the three-dimensional model in the three-dimensional map display level.

According to a second aspect of embodiments of the present disclosure, a data processing apparatus is provided, which includes:

a first obtaining module, configured to obtain a monitoring image captured at a monitoring point on a two-dimensional map;

a first judging module, configured to determine, according to the monitoring image, whether a preset map display level switching condition is satisfied;

a first determining module, configured to if the judging result of the first judging module is yes, obtain position information of the monitoring point on the two-dimensional map and determine a three-dimensional model pre-associated with the position information; and

a display module, configured to switch a map display level from a two-dimensional map display level to a three-dimensional map display level, and display the three-dimensional model in the three-dimensional map display level.

According to a third aspect of embodiments of the present disclosure, a computer readable storage medium storing a computer program is provided. When the computer program is executed by a processor, the method of any of the embodiments is implemented.

According to a fourth aspect of embodiments of the present disclosure, there is provided a computer device, comprising: a memory, a processor and a computer program stored in the memory and executable by the processor. When the computer program is executed by the processor, the method of any of the embodiments is implemented.

According to a fifth aspect of embodiments of the present disclosure, a computer program is provided. When the computer program is executed by a processor, the method of any of the embodiments is implemented.

It should be understood that the above general description and the following detailed description are merely exemplary and explanatory and are not intended to limit the present disclosure.

### BRIEF DESCRIPTION OF DRAWINGS

The accompanying drawings herein are incorporated in and constitute a part of the description, and these accompanying drawings illustrate embodiments consistent with the present disclosure and together with the description serve to explain the technical solutions of the present disclosure.

FIG. 1 is a flowchart of a data processing method provided by an embodiment of the present disclosure.

FIG. 2A and FIG. 2B are schematic diagrams of a track for a target monitoring object provided by an embodiment of the present disclosure.

FIG. 3 is a schematic diagram of an application scene provided by an embodiment of the present disclosure.

FIG. 4 is a block diagram of a data processing apparatus provided by an embodiment of the present disclosure.

FIG. 5 is a schematic diagram of a computer device for implementing the method of the present disclosure provided by an embodiment of the present disclosure.

### DETAILED DESCRIPTION

Exemplary embodiments will be described in detail herein, examples of which are shown in the accompanying drawings. The following description relates to the drawings, unless otherwise indicated, the same numerals in the different drawings represent the same or similar elements. The embodiments described in the following exemplary embodiments do not represent all embodiments consistent with the present disclosure. Rather, they are merely examples of apparatuses and methods consistent with some aspects of the disclosure as detailed in the appended claims.

Terms used in the present disclosure are for the purpose of describing particular embodiments only and are not intended to limit the present disclosure. The singular form “a/an”, “the”, and “the” used in the present disclosure and the attached claims are also intended to include the plural form, unless other meanings are clearly represented in the context. It should also be understood that the term “and/or” used herein refers to and includes any or all possible combinations of one or more associated listed terms. In addition, the term “at least one” herein represents any one of multiple types or any combination of at least two of multiple types.

It should be understood that although the present disclosure may use the terms such as first, second, and third to describe various information, the information should not be limited to these terms. These terms are only used to distinguish the same type of information from one another. For example, in the case of not departing from the scope of the present disclosure, first information may also be referred to as second information; similarly, the second information may also be referred to as the first information. Depending on the context, for example, the word “if” used herein may be interpreted as “upon” or “when” or “in response to determining”.

During urban/city management, when a certain position in the urban is abnormal, for example, crowded density of people, traffic congestion, frequent parking violation, sharing bicycle parking violation, domestic waste overflow, building garbage pilling, street stalls business or the like occurs, these abnormal situations may not be clearly perceived through a two-dimensional map. To improve the management capability for the city and the city safety quality, in embodiments of the present disclosure, a three-dimensional model for a monitoring point may be displayed based on a monitoring image.

To make a person skilled in the art better understand the technical solutions in the embodiments of the present disclosure, and to enable the aforementioned purposes, features, and advantages of the embodiments of the present disclosure to be more obvious and understandable, the technical solutions in the embodiments of the present disclosure are further explained in detail below by combining the accompanying drawings.

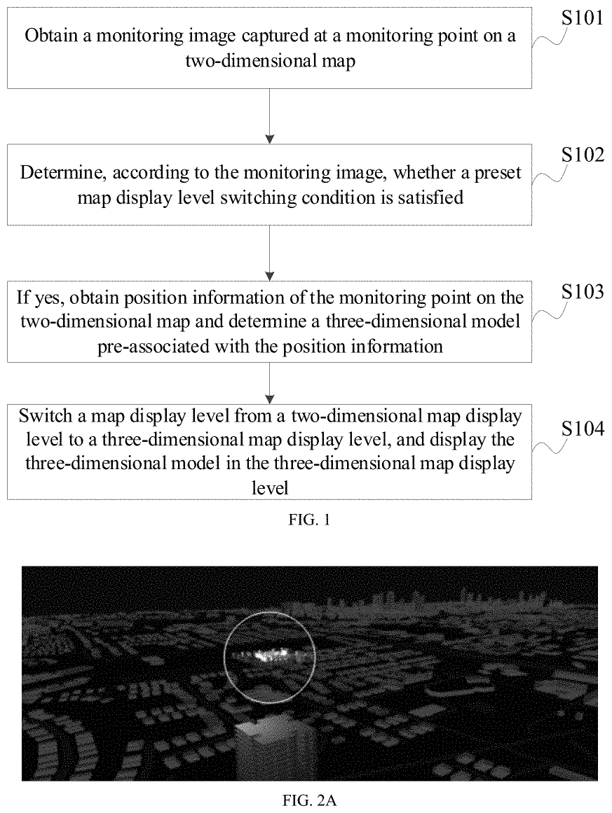

FIG. 1 is a flowchart of a data processing method provided by an embodiment of the present disclosure. As shown in FIG. 1, the method may include steps S101 to S104.

At step S101, a monitoring image acquired at a monitoring point on a two-dimensional map is obtained.

At step S102, whether a preset map display level switching condition is satisfied is determined according to the monitoring image.

At step S103, when the preset map display level switching condition is satisfied, position information of the monitoring point on the two-dimensional map is obtained, and a three-dimensional model pre-associated with the position information is determined.

At step S104, a map display level is switched from a two-dimensional map display level to a three-dimensional map display level, and the three-dimensional model is displayed in the three-dimensional map display level.

In the embodiments of the present disclosure, when a preset map display level switching condition is satisfied, a map display level is switched from a two-dimensional map display level to a three-dimensional map display level and the corresponding three-dimensional model in the three-dimensional map display level is displayed. Because the two-dimensional map still adopts in nature, the advantages of the two-dimensional map, such as low production and maintenance cost, simple and intuitive interface, and wide application range, are retained. Meanwhile, when the condition is satisfied, the map display level is switched to three-dimensional, and the associated three-dimensional model is displayed, so that certain detail information in the two-dimensional map can be displayed through the three-dimensional model, spatial details can be captured in the near scene, and physical spatial relationships that cannot be displayed in the two-dimensional map can be displayed. Therefore, the map display effect is improved.

With respect to step S101, one or more monitoring points and position information corresponding to the one or more monitoring points may be stored in the two-dimensional map, where the position information is two-dimensional position information including latitude and longitude coordinates of the monitoring points. A monitoring device at each monitoring point can capture monitoring images of the surrounding environment in real time. Multi-frame monitoring images are acquired per second to form a monitoring video.

With respect to step S102, map display levels may include at least two levels: a two-dimensional display level and a three-dimensional display level. Under the two-dimensional display level, each pixel on the map is displayed on the same plane, and only two-dimensional information is included, but not height information. For example, if there exists a 10-meter-tall rectangular building and a 5-meter-tall rectangular building, only two rectangles are displayed on the same plane under the two-dimensional display level, and height information of the two buildings is omitted. Under the three-dimensional display level, all or some of the pixels on the map include not only two-dimensional information, but also height information, and pixels of different heights are displayed on different planes.

The map display level switching condition is used to switch the map display level, for example, from the two-dimensional display level to the three-dimensional display level, or from the three-dimensional display level to the two-dimensional display level. In the case that the map display level switching condition is not triggered, the map display level may be set to the two-dimensional display level. For example, when the map software is initialized, the map may first be displayed in the two-dimensional display level. Only when the map display level switching condition is triggered, the display level is switched.

In some embodiments, the preset map display level switching condition includes that a preset event occurs or a target monitoring object is detected. The preset event may include, but is not limited to, at least one of: excessive crowd density, traffic congestion, frequent violations, vehicle parking violations, domestic waste overflow, building garbage pilling, street stalls business, or the like. Various algorithms or models, such as, density of people detection algorithms, urban congestion point detection algorithms, vehicle parking violation detection algorithms, may be used to detect whether the preset event occurs, and the present disclosure does not limit this. In addition, a human face recognition algorithm may be used to detect the target monitoring object from monitoring images. Those of skill in the art can understand that the specific detection method used does not affect the implementation of the technical solutions of the present disclosure.

Based on the monitoring image obtained in step S101, whether the preset map display level switching condition is satisfied can be determined. In some embodiments, the monitoring image may be input into a deep learning model that is pre-trained; and whether the preset event occurs is determined based on the output of the deep learning model. The deep learning model includes, but is not limited to, a convolutional neural network.

The deep learning model may output a logical identifier for representing whether or not a preset event occurs, and upon determining that a preset event occurs, the deep learning model may further output alert information, which may include time information at which the preset event occurred and category information of the preset event. As an example, the alert information may be: “A traffic congestion occurred on Oct. 21, 2019 at 19:00:25” or “Excessive density of people occurred on Oct. 1, 2019 at 9:30:45”. In addition, the alert information output by the deep learning model may include other information, such as spatial information corresponding to a location where the preset event occurred. In this case, as an example, the alert information may be: “A traffic jam occurred at Xizhimen Bridge on Oct. 21, 2019 at 19:00:25” or “Excessive density of people occurred at Beijing West Station on Oct. 1, 2019 at 9:30:45”. The above embodiments can provide alerts for a plurality of preset events based on deep learning algorithms.

With respect to step S103, position information of the monitoring point on the two-dimensional map, the position information on the two-dimensional map including latitude and longitude coordinates, can be obtained, and then it is determined whether the position information has a pre-associated three-dimensional model. If so, step S103 is performed, and if not, the map display level is maintained as the two-dimensional map display level.

The monitoring point described in embodiments of the present disclosure can include a target monitoring point within a region of interest, or other monitoring point outside the region of interest. The region of interest may be a pre-selected building, and accordingly, the target monitoring point may be a monitoring point installed inside the building. For the target monitoring point, a three-dimensional model of the building in which the monitoring point is located can be established in advance, and location information of the target monitoring point in the two-dimensional map can be associated with the corresponding three-dimensional model of the building in advance.

Taking a building as an example, a three-dimensional model with three-dimensional data (including length, width and height) can be established in a virtual three-dimensional space by a three-dimensional production software, the building is added in the model editing process, and then an indoor three-dimensional scene within the building is edited. Here the indoor three-dimensional scene does not need rich indoor details, as long as the details can represent the scene. Each building can correspond to multiple indoor three-dimensional scenes, which can be distinguished by floors. The planar coordinates of the monitoring points on the two-dimensional map are mapped to the three-dimensional map, and specific buildings and floors are associated. When scene information for a corresponding monitoring point is represented based on the spatial location, the map level can be switched from two-dimensional to three-dimensional.

To improve the display effect after switching the map display level, after establishing the three-dimensional model of the building in which the monitoring point is located, a display attribute of the three-dimensional model can further be adjusted. The display attribute includes at least one of: color, shape structure, transparency, or virtual and real attribute. By adjusting the display attribute, the color, the shape structure, the perspective relationship of each building, the warmth and coolness of the color, and the virtual and real relationship of the three-dimensional model on the entire display interface can be more coordinated after switching the map display level from the two-dimensional display level to the three-dimensional display level.

For the other monitoring points, the three-dimensional models associated with the position information of the monitoring points on the two-dimensional map are empty. Therefore, for each monitoring point on the two-dimensional map, whether the monitoring point is a target monitoring point can be determined by determining whether there is a pre-associated three-dimensional model of the position information of the monitoring point on the two-dimensional map. When switching the map display level, the scene information of the target monitoring point can be displayed by the three-dimensional map display level, while the scene information of the other monitoring points can be displayed by the two-dimensional map display level.

With respect to step S104, if the determination result of step S102 is “Yes”, at step S104, switching map level is performed. In a case that the map display level switching condition is that the preset event occurs, when the preset event occurs, the map display level is switched from two-dimensional to three-dimensional, so that the spatial location where the preset event occurs can be focused from far to near. Firstly, the approximate space in which the preset event occurs is displayed in the two-dimensional map, and then three-dimensional spatial information, such as a specific building and a specific floor, in which the preset event occurs is displayed in the three-dimensional model, which facilitates accurate positioning and viewing the detailed location where the preset event occurs.

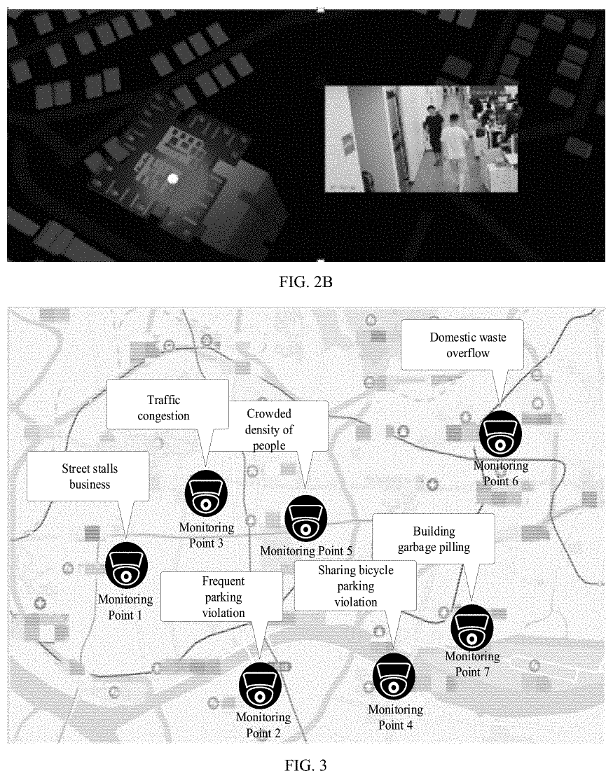

In a case that the map display level switching condition is that a target monitoring object is detected, a movement track of the target monitoring object may be determined according to monitoring images; and the space corresponding to the movement track in the three-dimensional model is displayed in the three-dimensional map display level. The archiving of the target monitoring object is provided based on a human face clustering algorithm. When viewing the movement track of the target monitoring object, if the movement track appears inside a building, the map display level is switched from two-dimensional to three-dimensional, so that the spatial position in which the target monitoring object appeared can be focused from far to near. In some embodiments, firstly, the building in which the target monitoring object appeared in the two-dimensional map is slowly raised through quasi-physical icons. Next, in the three-dimensional model, the position where the target monitoring object appeared is viewed according to the floors, thereby conveniently and quickly grasping the movement record of the target monitoring object inside the building. As shown in FIG. 2A, the inside of the circle is a target building in which the target monitoring object appeared. The corresponding target building may be marked in the three-dimensional model by an attribute such as color. Further, as shown in FIG. 2B, a dot represents a specific position of a target monitoring object in a building, and meanwhile, monitoring images including the target monitoring object may be displayed on a display screen of a monitoring center to track a movement track of the target monitoring object.

In some embodiments, the three-dimensional model includes floor information of the building and structure information of each floor. The floor information may include the number of floors of the building and the height of each floor. The structure information may include a shape, size and spatial layout of each floor, and the spatial layout may include the number of divided spaces, and a shape, size, relative position of each space, etc.

Based on this, displaying the three-dimensional model in the three-dimensional map display level can include: displaying the three-dimensional model in the three-dimensional map display level according to the floor information and the structure information of floors.

For example, the total number of floors in the three-dimensional model may be first displayed according to the floor information, and then for all or part of the floors, the structure information of the floors is respectively displayed. For a track monitoring scene of a target monitoring object, floor information of a floor where a monitoring track of the target monitoring object is located may be acquired, then structure information of the floor is acquired, and the three-dimensional model is displayed according to the floor information and the structure information of the floor.

When displaying the three-dimensional model, a display angle of the three-dimensional model may further be adjusted according to a received angle rotation instruction. The angle rotation instruction may include, but is not limited to, any of: a mouse input instruction, a keyboard input instruction, a voice input instruction, a touch screen input instruction, and the like. Taking a mouse input instruction as an example, by using the mouse, a user may drag the three-dimensional model to rotate an arbitrary angle. By obtaining the rotation angle, the three-dimensional model at the corresponding angle may be displayed on the display interface.

In embodiments of the present disclosure, by using a real-time full amount of monitoring image data resources, an intelligent analysis result of the monitoring image is displayed in the map, thereby implementing multi-algorithm capability display. The above solutions can be applied in the urban management process to instantly and comprehensively monitor the operation of the entire city based on spatial locations for the monitoring points (such as, criminal investigation security situation, public order security situation, traffic security situation, livelihood security situation, etc.), and to perceive urban emergencies including blacklisting deployment and control, crowd density of people, traffic point congestion, frequent vehicle parking violations, sharing bicycle parking violation, domestic waste overflow, building garbage pilling, street stalls business, and so on, thereby realizing intensification and visualization of urban management, and improving the management ability and safety quality of the city. Through the map, rich data and powerful AI (Artificial Intelligence) technology capability can be visually displayed. An example of an application scene of urban management is shown in FIG. 3.

For urban application scene, from the two-dimensional map to a three-dimensional model to display city data, it is possible to start from the city overall view, to the subordinate administrative areas, buildings, floors and finally to monitoring points step by step, so as to associate indoor and outdoor scene information, which is more advantageous for finding buildings and orientation. In embodiments of the present disclosure, not only the basic application of the two-dimensional map is retained, but also the two-dimensional map and the digital three-dimensional model are combined for in-depth application. From the traditional two-dimensional map to the digital three-dimensional model, as a new generation of artificial intelligence map, the overall view of the city is displayed in the distant scene, and the spatial details are captured in the near scene, which can solve the problem of physical space relationship that cannot be solved by a two-dimensional plane, and realize multi-scene and multi-dimensional city data application based on spatial location.

It can be understood by those skilled in the art that, in the described method of the detailed description, the drafting order of each step does not mean the strictly executed order and does not form any limitation to the implementation process, and the specific execution order of each step should be determined by its function and possible intrinsic logic.

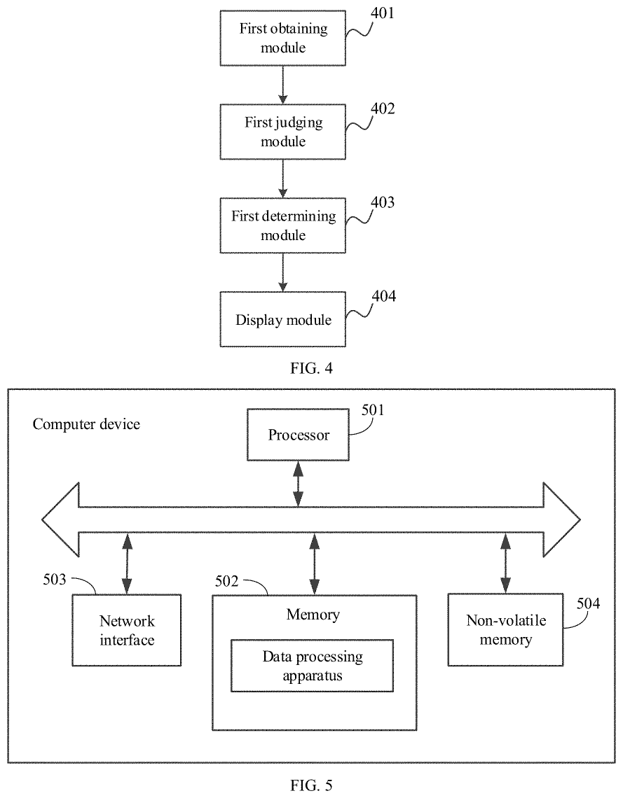

As shown in FIG. 4, embodiments of the present disclosure further provide a data processing apparatus, which includes:

a first obtaining module 401, configured to obtain a monitoring image captured at a monitoring point on a two-dimensional map;

a first judging module 402, configured to determine, according to the monitoring image, whether a preset map display level switching condition is satisfied;

a first determining module 403, configured to if the judging result of the first judging module is yes, obtain position information of the monitoring point on the two-dimensional map and determine a three-dimensional model pre-associated with the position information;

a display module 404, configured to switch a map display level from a two-dimensional map display level to a three-dimensional map display level, and display the three-dimensional model in the three-dimensional map display level.

In some embodiments, the preset map display level switching condition comprises that: a preset event occurs; or a target monitoring object is detected.

In some embodiments, the display module comprises: a determining unit, configured to determine a movement track of the target monitoring object according to the monitoring image if the target monitoring object is detected; and a first display unit, configured to display a space corresponding to the movement track in the three-dimensional model in the three-dimensional map display level.

In some embodiments, the apparatus further comprises: an establishing module, configured to establish the three-dimensional model of a building in which the monitoring point is located; and an associating module, configured to associate the three-dimensional model with the position information.

In some embodiments, the apparatus further comprises a first adjusting module configured to adjust a display attribute of the three-dimensional model.

In some embodiments, the display attribute comprises at least one of: color, shape structure, transparency, or virtual and real attribute.

In some embodiments, the three-dimensional model comprises floor information of the building and structure information of each floor.

In some embodiments, the display module comprises: a second display unit, configured to display the three-dimensional model in the three-dimensional map display level according to the floor information and structure information of floors.

In some embodiments, the apparatus further comprises: a second adjusting module, configured to adjust a display angle of the three-dimensional model according to a received angle rotation instruction.

In some embodiments, the apparatus further comprises: an inputting module, configured to input the monitoring image into a deep learning model that is pre-trained; and a second judging module, configured to determine, according to output of the deep learning model, whether the preset event occurs.

In some embodiments, the deep learning model is further configured to: output alert information comprising time information and spatial information at which the preset event occurred and category information of the preset event.

In some embodiments, the functions or the included modules of the apparatus provided by the embodiments of the present disclosure may be configured to execute the method described in the foregoing method embodiments. For specific implementation, reference may be made to the description of the foregoing method embodiments. For brevity, details are not described herein again.

The apparatus embodiments described above are merely schematic, and the modules described as separate components may or may not be physically separate, and the components displayed as modules may or may not be physical modules, may be located in one place, or may be distributed to a plurality of network modules. Some or all of the modules may be selected according to actual needs to achieve the purpose of the solution of the present description. A person of ordinary skill in the art would understand and implement without creative efforts.

Embodiments of the apparatus of the present description may be applied to a computer device, such as a server or a terminal device. The apparatus embodiment may be implemented by software, or implemented by hardware or a combination of software and hardware. Taking software as an example, as an apparatus in a logical sense, the apparatus is formed by reading, with a processor for processing a file where the apparatus is located, corresponding computer program instructions in a non-volatile memory into a memory. From the hardware level, as shown in FIG. 5, it is a hardware structural diagram of a computer device in which the apparatus of the present description is located. In addition to the processor 501, the memory 502, the network interface 503, and the non-volatile memory 504 shown in FIG. 5, a server or an electronic device including the apparatus in the embodiments generally includes other hardware according to actual functions of the computer device, which will not be described herein again.

Correspondingly, the embodiments of the present disclosure further provide a computer storage medium storing a computer program. When the computer program is executed by a processor, the method of any of the embodiments is implemented.

Correspondingly, the embodiments of the present disclosure further provide a computer device, comprising: a memory, a processor and a computer program stored in the memory and executable by the processor. When the computer program is executed by the processor, the method of any of the embodiments is implemented.

Correspondingly, the embodiments of the present disclosure further provide a computer program. When the computer program is executed by a processor, the method of any of the embodiments is implemented.

The present disclosure may take the form of a computer program product implemented on one or more storage media including program code therein. The storage media includes, but are not limited to, a disk memory, a CD-ROM (Compact Disc Read-Only Memory), an optical memory, etc. Computer usable storage media, including permanent and non-permanent, removable and non-removable media, may use any method or technology to implement information storage. The information may include computer readable commands, data structures, modules of programs, or other data. Examples of storage media of a computer include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, read-only disc, compact disc read-only memory (CD-ROM), digital versatile disc (DVD) or other optical storage, magnetic cassette, magnetic tape disk storage or other magnetic storage device or any other non-transmission medium, and may be configured to store information that can be accessed by the computer device.

Other embodiments of the present disclosure will readily occur to those skilled in the art upon consideration of the description and practice of the description disclosed herein. The present disclosure is intended to cover any variation, use or adaptive variation of the present disclosure that follows the general principles of the present disclosure and includes common general knowledge or customary technical means in the art which are not disclosed in the present disclosure. The description and examples are considered as exemplary only, and the true scope and spirit of the disclosure are indicated by the following claims.

It should be understood that the present disclosure is not limited to the precise structures already described above and shown in the drawings, and various modifications and changes may be made without departing from the scope thereof. The scope of the present disclosure is limited only by the appended claims.

The above description is merely exemplary embodiments of the present disclosure, and is not intended to limit the present disclosure. Any modifications, equivalent replacements, improvements and the like made within the spirit and principle of the present disclosure should be included within the scope of protection of the present disclosure.

Descriptions of the above embodiments tend to emphasize differences between the various embodiments, and the same or similar parts may be referred to each other, and for simplicity, are not described herein again.

What is claimed is:

1. A data processing method, comprising:
obtaining a monitoring image captured at a monitoring point on a two-dimensional map;
determining, according to the monitoring image, whether a preset map display level switching condition is satisfied;
in response to determining that the preset map display level switching condition is satisfied,
obtaining position information of the monitoring point on the two-dimensional map, and
determining a three-dimensional model pre-associated with the position information;
switching a map display level from a two-dimensional map display level to a three-dimensional map display level; and
displaying the three-dimensional model in the three-dimensional map display level.

2. The method of claim 1, wherein the preset map display level switching condition comprises that:
a preset event occurs; or
a target monitoring object is detected.

3. The method of claim 2, wherein displaying the three-dimensional model in the three-dimensional map display level comprises:
in response to determining that the target monitoring object is detected, determining a movement track of the target monitoring object according to the monitoring image; and
displaying a space corresponding to the movement track in the three-dimensional model in the three-dimensional map display level.

4. The method of claim 1, further comprising:
establishing the three-dimensional model of a building in which the monitoring point is located; and
associating the three-dimensional model of the building with the position information.

5. The method of claim 4, further comprising: after establishing the three-dimensional model of the building in which the monitoring point is located,
adjusting a display attribute of the three-dimensional model of the building.

6. The method of claim 5, wherein the display attribute comprises at least one of: color, shape structure, transparency, or virtual and real attribute.

7. The method of claim 4, wherein the three-dimensional model of the building comprises floor information of the building and structure information of each floor.

8. The method of claim 7, wherein displaying the three-dimensional model in the three-dimensional map display level comprises:
displaying the three-dimensional model in the three-dimensional map display level according to the floor information and structure information of floors.

9. The method of claim 1, further comprising: after displaying the three-dimensional model in the three-dimensional map display level,
adjusting a display angle of the three-dimensional model according to a received angle rotation instruction.

10. The method of claim 2, further comprising:
inputting the monitoring image into a deep learning model that is pre-trained; and
determining, according to output of the deep learning model, whether the preset event occurs.

11. The method of claim 10, wherein the deep learning model is further configured to:
output alert information comprising time information and spatial information at which the preset event occurred and category information of the preset event.

12. A non-transitory computer readable storage medium storing a computer program, wherein when the computer program is executed by a processor, the processor is caused to perform operations comprising:
obtaining a monitoring image captured at a monitoring point on a two-dimensional map;
determining, according to the monitoring image, whether a preset map display level switching condition is satisfied;
in response to determining that the preset map display level switching condition is satisfied,
obtaining position information of the monitoring point on the two-dimensional map, and
determining a three-dimensional model pre-associated with the position information;
switching a map display level from a two-dimensional map display level to a three-dimensional map display level; and
displaying the three-dimensional model in the three-dimensional map display level.

13. A computer device, comprising: a memory, a processor and a computer program stored in the memory and executable by the processor, wherein when the computer program is executed by the processor, the processor is caused to execute operations comprising:
obtaining a monitoring image captured at a monitoring point on a two-dimensional map;
determining, according to the monitoring image, whether a preset map display level switching condition is satisfied;
in response to determining that the preset map display level switching condition is satisfied,
obtaining position information of the monitoring point on the two-dimensional map, and
determining a three-dimensional model pre-associated with the position information;
switching a map display level from a two-dimensional map display level to a three-dimensional map display level; and
displaying the three-dimensional model in the three-dimensional map display level.

14. The device of claim 13, wherein the preset map display level switching condition comprises that:
a preset event occurs; or
a target monitoring object is detected.

15. The device of claim 14, wherein displaying the three-dimensional model in the three-dimensional map display level comprises:
in response to determining that the target monitoring object is detected, determining a movement track of the target monitoring object according to the monitoring image; and
displaying a space corresponding to the movement track in the three-dimensional model in the three-dimensional map display level.

16. The device of claim 13, wherein the processor is further caused to execute operations comprising:
establishing the three-dimensional model of a building in which the monitoring point is located; and
associating the three-dimensional model of the building with the position information.

17. The device of claim 16, wherein the processor is further caused to execute operations comprising: after establishing the three-dimensional model of the building in which the monitoring point is located,
adjusting a display attribute of the three-dimensional model of the building.

18. The device of claim 17, wherein the display attribute comprises at least one of: color, shape structure, transparency, or virtual and real attribute.

19. The device of claim 16, wherein the three-dimensional model of the building comprises floor information of the building and structure information of each floor.

20. The device of claim 19, wherein displaying the three-dimensional model in the three-dimensional map display level comprises:
displaying the three-dimensional model in the three-dimensional map display level according to the floor information and structure information of floors.
